(19) United States
(12) Patent Application Publication
(10) Pub. No.: US 2015/0355820 A1
(43) Pub. Date: Dec. 10, 2015

(54) Device And Method For Media Player Mated To Printed Media

(71) Applicants: Donn K. Harms, Del Mar, CA (US); Nargiz Makhsudova, San Diego, CA (US)

(72) Inventors: Donn K. Harms, Del Mar, CA (US); Nargiz Makhsudova, San Diego, CA (US)

(21) Appl. No.: 14/733,903

(22) Filed: Jun. 8, 2015

Related U.S. Application Data
(60) Provisional application No. 62/008,921, filed on Jun. 6, 2014.

(51) Int. Cl. G06F 3/0484; G06F 3/0481

(52) U.S. Cl. CPC G06F 3/04842; G06F 3/04817

(57) ABSTRACT

An album having bound pages engaged to a cover having a media player engaged thereto, and a method for forming the album are disclosed. The album features a cover having a built in media player for digital media files. The cover when bound to a plurality of pages of indicia such as photographs, with the media player having digital files relating to the photos therein, provides the user with both still and moving media concerning the subject matter of the indicia on the pages. Using the album as a wedding album will have still photos of the wedding on the bound pages, and can have moving video and audio playable on the engaged video player in the cover for the wedding album.

This application claims priority to U.S. Provisional Patent Application Ser. No. 62/008,921 filed on Jun. 6, 2014 and which is incorporated herein in its entirety by this reference thereto.

### FIELD OF THE INVENTION

The device and method herein, are in the field of media players. More particularly the device and method herein concern a media cover or housing for covering interior pages which have printed or positioned indicia thereon, where video and/or sound media may be stored or routed to memory in the cover or a media player in the cover, which is accessible by a connected media player, or wherein the media player itself forms a cover for an underlying album.

### BACKGROUND OF THE INVENTION

Media playing device have been employed to display videos and photos form many years. Most have evolved in the portable mode, to include a display formed of an LCD display, which is operatively engaged to a computing device with onboard memory whereby videos and photos may be stored to memory, and depicted on the video display using software running on the onboard computing device adapted to convert stored media files into viewable video photos and movies and the like, on the video display.

Such video playing devices and capability are included in smartphones, pad computers, and modern televisions and gaming devices. However, all of these devices include expensive additional components, and hard protective housings or surrounding cases, and generally include the video and photo depiction upon a video display, as one of many functions performed by the device itself.

Consequently, such devices are not well adapted or configured to provide video, audio, and photo depiction and playback, for a single purpose or reason. Further, even if such devices were to be employed for instance to provide video depiction in conjunction with an event, it would be costly due to the hard cases as well as wasteful in that the device would not be employable for any other reason, and because of the hard case and hard wiring thereto, it would not be reusable easily or recyclable.

Further, while there are many types of albums and collections of records which may be placed into pages in a single bound collection, currently there exists no manner to attach or affix a media display and player, to such bound collections, as a cover and as a player for media related to the internal bound material. Such would be great to employ to provide videos of a wedding along with the photos inside the album of the same wedding.

As such, there exists an unmet need, for a media player configured as a fixed cover for a collection of records or other paper media, or for a bound material cover which will function as a media storage device adapted to communicate media to engageable media players with the cover. Such a device should be configured for provision of slide shows of photos, videos, and other displayable media and the like, which can be associated with bound paper or printed material relating to a single person, event, venue, or other individual matter or event which would benefit from a video display. Such a device and method however, should ideally providable as a housing which is customizable with indicia thereon, related to the subject matter of the media to be displayed on the video display contained in the housing.

Further, such a device in addition to employing a system to customize the housing to the video or other media stored in memory for display on the video display screen, should in some modes provide a cover or housing which may be reused or recycled easily, to allow continuous sequential employment of a media player with subsequent customized housings bearing informational or decoration type indicia thereon, and having electronic memory for media which may be communicated to one or a plurality of media players using wired or wireless communication.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### OBJECTS OF THE INVENTION

It is an object of this invention to provide a media playing device which is formed as, or attachable to, a cover for bound indicia such as photos or printed material.

Another object of the instant invention is to provide a cover or housing which may be indicia-customized as a cover for the bound material within.

An additional object of this invention is to provide a cover for bound material which includes onboard electronic memory or means to communicate with cloud storage of media files, playable on a media player, which may be engaged with or adapted to communicate with the cover.

Another object of this invention is to provide such cover for a photo album which includes a video display component, or is operatively engageable to one or a plurality of video display components, whereby communicated electronic files in memory may be communicated to the media player, and are paired to a collection of still photos of an event or venue or subject, related to the video depicted by the device, by a photo provider such as in large chain stores offering photo printing.

A further object of this invention is to provided such indicia-customizable housings or covers, adapted to communicate media files to a video playing device which may be operatively disengaged and reused, and where the housing or cover may be reused or recycled.

Other objects and advantages will become obvious to those skilled in the art when taken into consideration with the following drawings and specifications.

These and other objects, features, and advantages of the present device and method, as well as the advantages thereof over existing prior art, which will become apparent from the description to follow, are accomplished by the improvements described in this specification and hereinafter described in the following detailed description which fully discloses the invention, but should not be considered as placing limitations thereon.

### SUMMARY OF THE INVENTION

In accordance with the purposes of the disclosed device an method as embodied and broadly described herein, the present invention provides a device and method for operative employment of media playing components engaged to indicia-customizable album covers, and housings herein, formed of flexible material. Both the media playing component, and the housing or cover for underlying media or prints, may be reused and/and recycled in some mode. In all modes of the device and method herein, preferably the formed cover or housing, may be indicia-customized using a printer to place indicia thereon relating to the video placed in electronic memory and playable on the video media playing component.

In one mode, the system herein, employs a housing or album cover for bound material which may be formed of initially flexible material such as paper, paperboard, cardboard, or plastic. The cover can include onboard electronic memory, a microprocessor running software adapted communicate electronic files with a communicating media device, and electrical power. The cover or housing can have an aperture or recess sized to engage a media player. The display of the media player is viewable through the aperture or engaged or positioned within the recess, and is surrounded by the surface of the formed housing or album cover.

The media player is configured to easily engage to or within the cover providing the housing using adhesive, and/or a frictional engagement and/or hook and loop material, and stay in or proximate to a formed recess in the housing sized to surround and operatively engage with the video display screen of the media player. In this mode the housing or cover itself is sized to be engaged with an album or book having printed media therein such as photos of an event, or depictions of a venue, or printed records, other related subject matter to the media files which are placed in electronic memory of the media player and which may be depicted on the video display of the media player.

In another mode of the device and method herein, the housing is customizable by employment of a printer to thereby impart customized indicia to the cover or housing provided by the device. The indicia may relate to an event, venue, company, event, or other subject matter, which itself relates to the electronic media placed into memory of the cover or housing which is communicable to the media playing device which will be employed by the user for a subsequent display of the media hosted on or communicated through the cover, in the form of a video, photos, or a slide show, on a video display.

In another preferred mode of the device and method adapted to the medical field, the housing may imparted with customized indicia relating to a patient which may include an explanation of the video hosted on the engaged media player. The media player itself may communicate with onboard electronic memory or through communication initiated by electronics in the cover, to play one or a plurality of electronic media files which concern the patient placed in memory for playback by the user.

The media player may be engageable to the customized housing or cover, or in all modes, may communicate with onboard memory in the housing or cover, so as to pair the electronic files held in the cover or housing with a media player. The cover or housing provided by the device, may be delivered to a medical professional for the patient, or the patient directly. Using the electronic media stored in device memory, or communicated through the device itself to the media player, the patient or doctor may review and play the media files in the form of videos or photos which relate to the patient.

Such communicated files to a media player using the cover or housing device herein, might include an electronic screening of the patient such as a CAT Scan or an MRI, or one or a series of X-rays. The indicia placed on the cover or housing could identify the patient, and thereby allow medical professionals to review the media displayed on a connected video display.

Subsequently, the cover or housing may be disconnected from communication with the media device, and recycled or reused, as it is formed of flexible material such as paper or paperboard or cardboard or plastic or another such recyclable material.

If a mated media player is provided, it may also be reused, by mating it to electronic memory on or communicated through another housing or cover device having media files stored thereon or communicated therethrough, to the media player capable of electronic mating therewith for subsequent use.

With respect to the above description, before explaining at least one preferred embodiment of the herein disclosed media player and housing invention in detail, it is to be understood that the invention is not limited in its application to the details of construction and to the arrangement of the components in the following description or illustrated in the drawings. The device and method herein described and disclosed in the various modes and combinations is also capable of other embodiments and of being practiced and carried out in various ways which will be obvious to those skilled in the art. Any such alternative configuration as would occur to those skilled in the art is considered within the scope of this patent. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other media players adapted to engage customized housings for carrying out the several purposes of the present disclosed device. It is important, therefore, that the claims be regarded as including such equivalent construction and methodology insofar as they do not depart from the spirit and scope of the present invention.

### BRIEF DESCRIPTION OF DRAWING FIGURES

The accompanying drawings, which are incorporated herein and form a part of the specification, illustrate some, but not the only nor exclusive examples of embodiments and/or features of the disclosed media playing bound material cover device. It is intended that the embodiments and figures disclosed herein are to be considered illustrative of the invention herein, rather than limiting in any fashion.

In the drawings:

FIG. 1 depicts a top view of a media player engaged with the housing herein providing the cover for bound media and showing a folding cover.

FIG. 2 displays one mode of the device and method herein, wherein the housing bearing the media player is adapted for engagement as the cover of a book or album or other bound printed media such as photos of an event or other subject related to the electronic video files stored in memory on the player.

FIG. 3 shows a side view of the cover device engaged with the book or album of bound printed material from the side view from FIG. 2.

FIG. 4 depicts a top plan view of the housing for cover and engagement of the media player being imparted with customized indicia using a printer prior to mating with a media player.

FIG. 5 displays a rear perspective view a mode of the housing used as a cover for bound material, wherein an aperture is adapted to operatively engage a removable media player.

FIG. 6 depicts a mode of the device wherein the housing providing a cover for underlying printed media may be customized with indicia relating to a patient for which the stored media for display on the video display relates.

FIG. 7 depicts a mode of the device where media files may be loaded to onboard electronic memory wirelessly or by wire to the housing first, and the housing later paired with a media player in a wired or wireless communication therewith.

FIG. 8 depicts the housing holding either a self contained media player or memory and communication components per FIG. 10, engaged as to cover to printed material, photos, or other indicia on internal pages.

FIG. 9 shows the device as in FIG. 8, with a rear cover engaged which also may bear indicia from printing.

FIG. 10 depicts a mode of the device formed to be the cover to bound printed material, wherein onboard memory and communication components will mate to a media player proximate thereto.

FIG. 11 shows the device in a mode where the housing and media player are a combined cover for a patient chart of bound records.

FIG. 12 depicts a mode of the device herein wherein the housing has a media player and is engaged as the cover to an underlying collection of indicia on pages such as photos, or printed matter.

FIG. 13 shows a mode of the device formed to be a cover for bound material, wherein frangible lines are imparted to the sections rendering them removable and the device adjustable in size to match the size of underlying indicia such as printed materials.

FIG. 14 shows a mode of the device herein, wherein an object such as a product is the trigger to activate the media player to play sound and or video concerning the product when moved.

FIG. 15 depicts a typical mode of the method of forming a book or bound internal paged indicia where the buyer chosen internal indicia such as photos, is first printed to interior pages and the buyer chosen media such as video and audio, which may relate to the indicia, is loaded to memory for the media player positioned in the cover for the printed indicia pages.

### DETAILED DESCRIPTION OF THE INVENTION

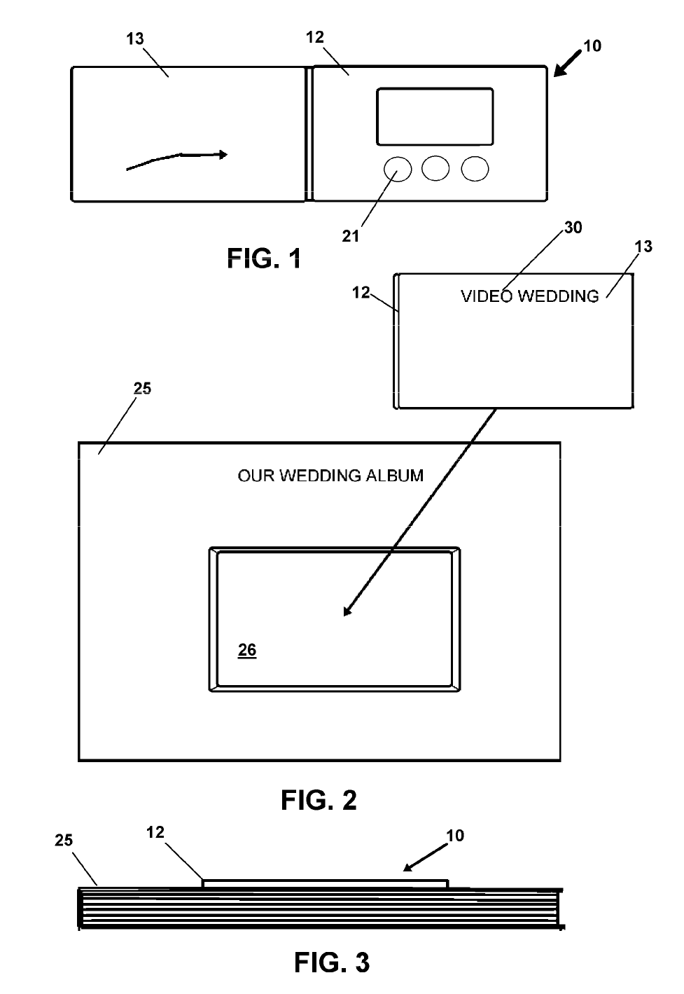

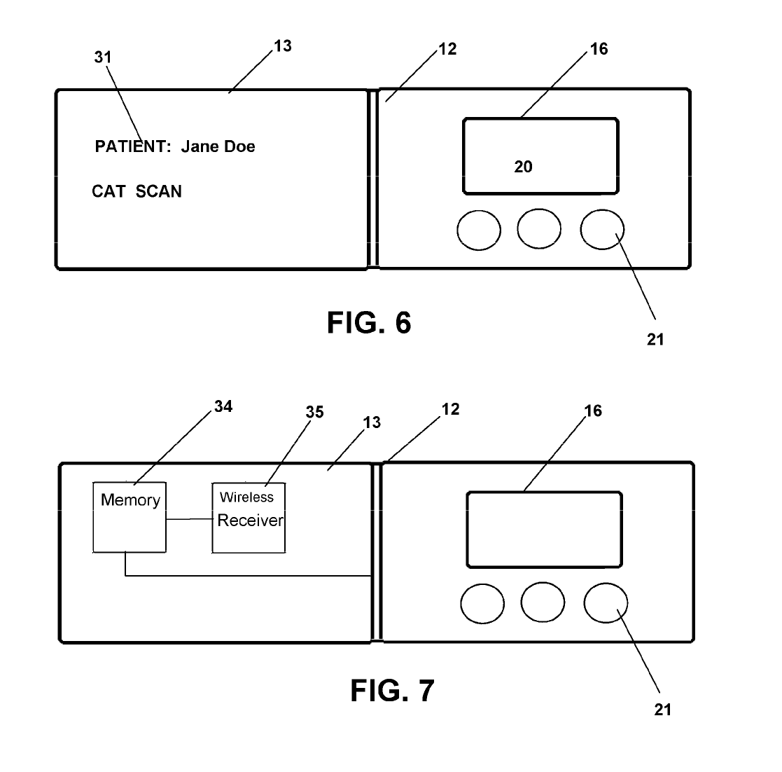

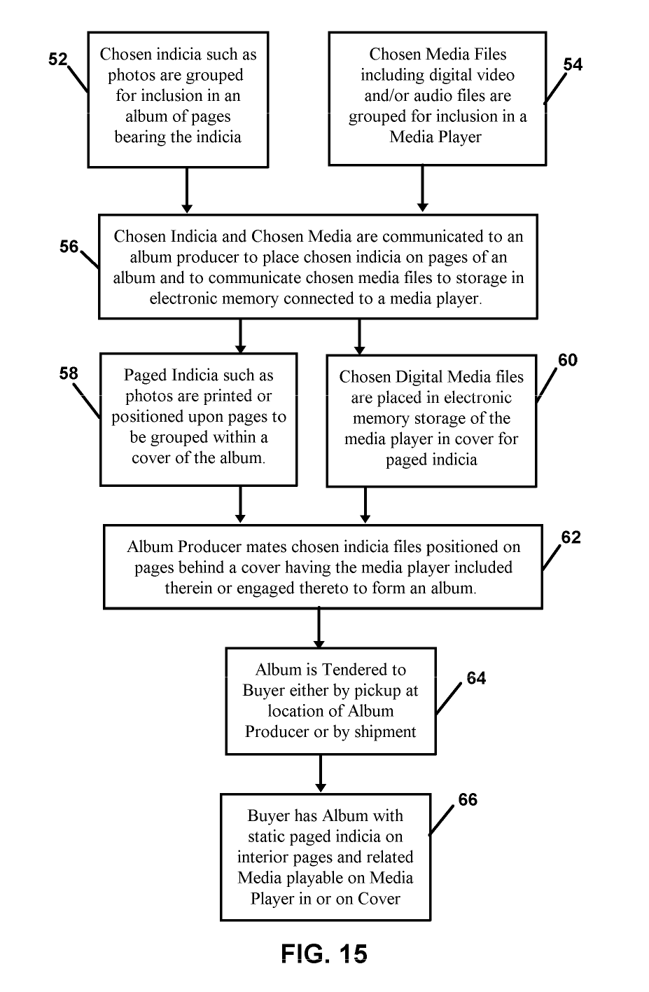

Now referring to drawings in FIGS. 1-15, wherein similar components are identified by like reference numerals, there is seen in FIGS. 1-3, the device 10 which may be employed in the method herein noted in FIG. 15 although other modes of the device herein may also work well in the method noted.

In a first preferred mode of the device 10 and system herein, a cover 12 which may include an engaged folding cover 13 is formed of flexible material such as paper, paperboard, cardboard, or plastic. The cover 12 has an aperture 16 adapted to engage a media player 18 (FIG. 5) wherein the video display 20 screen operatively engaged with the media player 18 is viewable through the aperture 16. Additionally, the cover may include control surfaces 21 which are in communication with switches of the media player 18, whereby a user may touch or push the control surfaces 21 to control the media player 18 and operate it to display video depictions upon the display 20 screen.

The media player 18 may be a self contained unit with electronic memory and a computing device operatively engaged with such memory and the display 20 screen. Onboard software adapted to employ electronic media files stored in electronic memory is included in computer memory and the software may be operated and controlled by the user using the control surfaces 21 which may be touched or depressed or otherwise operated to communicate user preferences. Alternatively as noted herein, the media player may be separate from the material forming the cover to underlying material, but in operative communication with memory housed in the cover which contains media files.

In one mode of the device 10 and method herein shown in FIGS. 2-3, which employs the device 10 to be paired as the cover for a book or album 25 containing printed media such as photos of an event, or a wedding, or other printed media on a subject. The cover 12 with the media player 18 engaged, is configured to easily engage with and become part of the cover for a book or album 25, using adhesive, and/or a frictional engagement to a formed recess 26 on a surface of the book or album 25. The media in electronic memory would be videos of the wedding and could also include electronic versions of the photos contained in the album.

In all modes of the device 10 and method herein, the cover 12 for the media player and cover of the printed media may be customized with indicia relating to the video or media files stored in electronic memory and playable on the video display 20. The cover 12 may be formed of foldable material which is adapted in a planar mode before engagement with the media player 18, and for printing of indicia 30 thereon using a printer 32 or other means to impart indicia 30 to the surfaces of the cover 12 which are viewable by a user with the media player 18 operatively engaged.

The indicia 30 which may become part of the cover with the media player, may relate to an event, venue, company, event, or other subject matter, which itself relates to the electronic media placed into memory available to the media playing device 18, which will be employed by the user for a subsequent display of the media in the form of a video, photos, or a slide show, on a video display 20.

For instance the indicia 30 placed on the cover 12 which will function as the cover for the printed media, may concern a wedding event, or might concern a tour for a particular venue, or might concern a hotel or resort. Because the material forming the cover 12 is lightweight and flexible initially, once engaged to underlying printed media, it may be mailed or shipped in envelopes allowing the device 10 to be shipped or mailed to users.

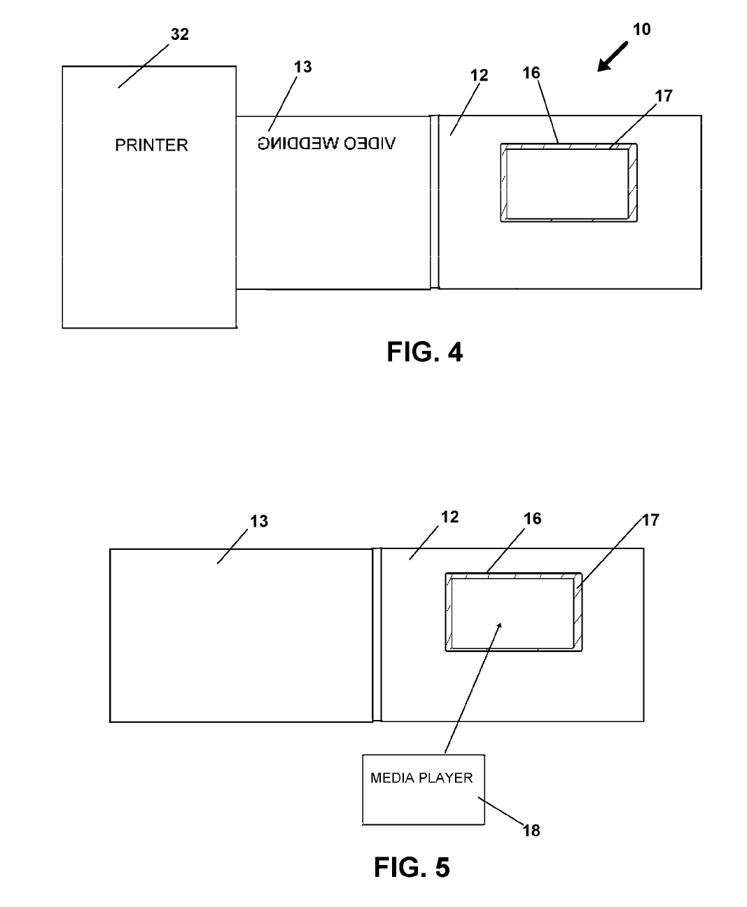

As shown in FIG. 5, which depicts a rear side of the cover 12 as shown in FIG. 4, an aperture 16 formed in the cover material may be sized to engage around the media player 18 operatively engaging it. A ledge 17 may be provided on a surface which will contact the area surrounding the edge of the video display 20 to hold it from coming out of the aperture 16. A rear cover (not shown) may be attached behind the engaged media player 18 to protect it, however the media player 18 may be self contained and not require such. Once assembled the media player 18 engaged with the cover 12 can be engaged as the cover to pages of underlying printed media.

In another preferred mode of the device 10 and method adapted to the medical field, the cover 12 may imparted with customized indicia 31 relating to a patient which may include an information concerning the content of the video stored in electronic memory and hosted on the engaged media player 18 or a communicating media player 18. The media player 18 itself may have one or a plurality of electronic media files which concern the patient placed in memory for playback by the user.

The media player 18 is engageable to the indicia-customized cover 12, and the paired cover 12 and media player 18 as the cover for underlying printed media, are deliverable to a medical professional, or the patient themself. The media file such as an MRI or CAT scan or X-ray may be reviewed using the device 10. The indicia 30 on the cover would identify the patient, and thereby allow medical professionals to review the media displayed on the video display 20.

This mode may be recyclable, as subsequent to viewing the cover 12 may be removed and recycled as it is formed of flexible material such as paper or paperboard or cardboard or plastic or another such recyclable material. The media player 18 may also be reused, once removed from the aperture 16, by loading new media files thereon, and pairing it with a subsequent cover 12 which is indicia-customized to a new patient being reviewed at that time.

FIG. 7 depicts another mode of the device 10 where media files may be loaded to onboard electronic memory 34 of the material forming the cover wirelessly or by wire such as USB (not shown) first. A wired or wireless receiver 35 for the media files will communicate them to onboard memory 34. The onboard memory 34 is in wired communication with connector operatively positioned such that when the media player is engaged to the cover 12 in a registered positioning, such as within the aperture 16 and against the ledge 17, that the electronic memory is operatively communicated to the media player 18.

This mode of the device 10 and method, will allow media files to be loaded to the cover 12 first, such as by an X-ray technician, or an MRI lab, and the cover 12 then may later be mated to a media player 18 which is adapted as noted above, to employ the stored electronic files, to depict video on the video display 20 and function as a cover for underlying printed media.

Also in this mode, the cover 12 may be customized with indicia prior to operative engagement to the media player. This mode would allow the cover 12 to be loaded with electronic video files, first, and the cover can then be mailed, or transported to be mated to a media player 18. In this mode, where media files are loaded in memory on the cover 12 the media player 18 might be a smartphone, or pad computer, and the cover 12 can have an engagement position sized and configured to operatively engage with the media player 18 intended. The engaged media player 18 to the cover 12 acting as the printed media cover, would then have access to the stored media files in the cover 12 electronic memory 34 for playing. The connection of the stored media files in electronic memory 34 might also be wireless by using transceiver as the wireless receiver 35 which is capable of WiFi or Bluetooth communication with the intended media player 18 once it is engaged to the cover 12.

This mode of the device 10 and method would allow for the communication of indicia-customized covers 12 with media files relating to the indicia 30 and/or underlying printed media, to be stored in electronic memory 34, whereafter the user would connect a media player 18 in their possession, or a media player 18 such as a smart phone or pad computer, for which the cover 12 is adapted to operatively engage with in advance.

Once engaged, the chosen media player 18 would be able to display the stored video files from electronic memory 34 and have the related indicia 30 for concurrent viewing on portions of the cover 12. Also available would be the underlying printed media if the cover 12 provides the cover therefor.

In all modes of the device 10 and method herein, the media files may be communicated to electronic memory locally, or over a network such as the internet to a remote location. This for instance would allow potential users to be offered a video to accompany the photos they are picking up from a store, which relates to those photos, or is a slide show thereof. The video could be communicated to the local store over a network and loaded to an assembled device 10, or the device 10 might be assembled at the store by first imparting customized indicia 30 to the cover 12 using a local printing means. The customized indicia 30 may be one or a plurality of the photos being picked up or scenes from the video being stored to the device 10. The customized cover 12 could be paired locally with the media player 18, or it could be locally adapted to communicate the playable video files in memory 34 to a user possessed media player 18 such as a smart phone.

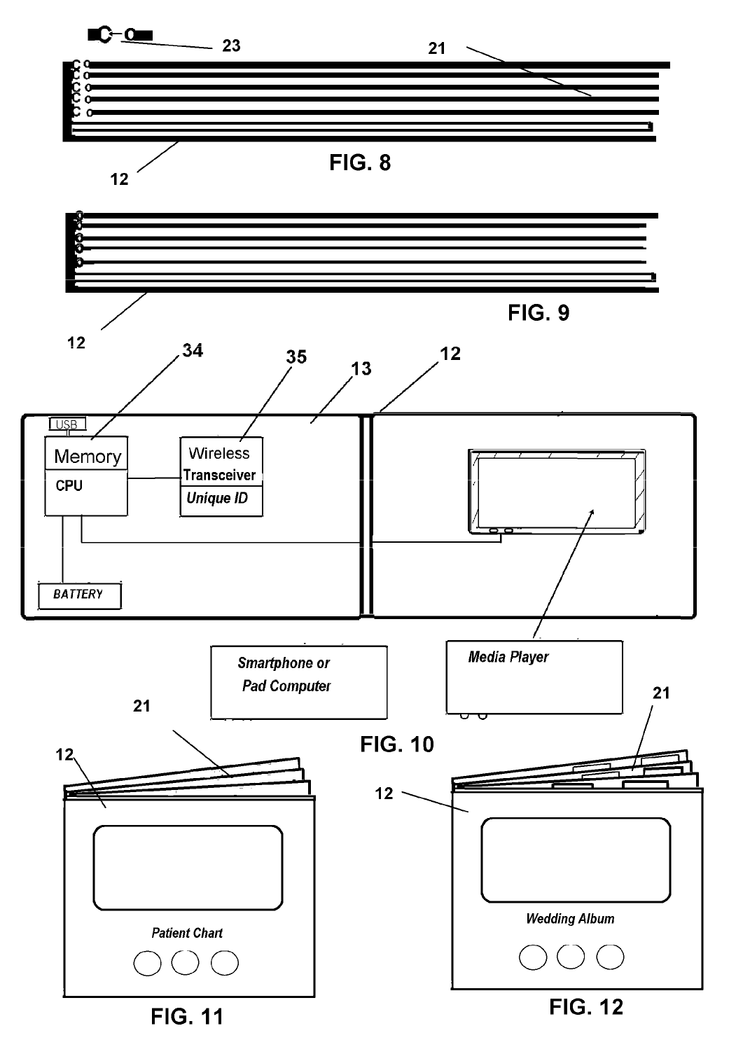

FIG. 8 depicts the cover holding either a self contained media player or memory 34 and communication components per FIG. 10, engaged as to form the cover to printed media in bound pages 21. A spine extending from the cover 12 providing the cover would could be engageable with pages 21 using mating connectors 23.

FIG. 9 shows the device as in FIG. 8, with a rear cover engaged which also may bear indicia from a printer.

FIG. 10 depicts a mode of the device 10 formed to be the cover for underlying printed media wherein onboard memory 34 and communication components 35 will mate to a media player proximate thereto and allow access to the electronic media files in memory 34 for depiction on the media player communicating therewith.

FIG. 11 shows the device 10 in a mode where the cover 12 and media player are a combined cover for a patient chart of bound records.

FIG. 12 depicts a mode of the device herein wherein the cover has an engaged or engageable media player and is engaged as the cover to an underlying collection of printed matter pages 21 such as photos.

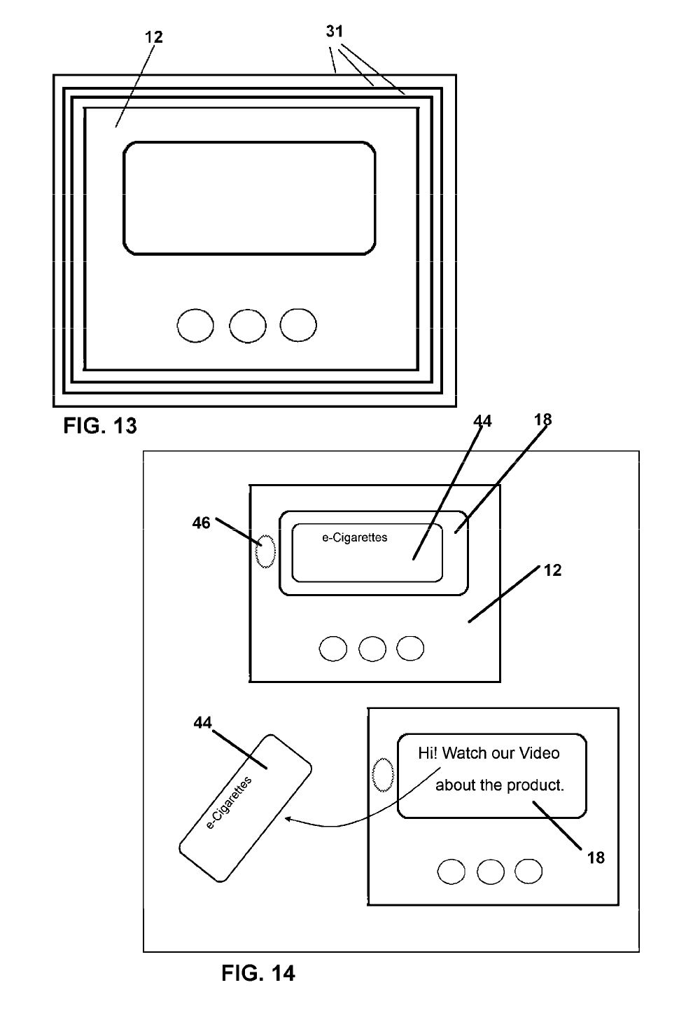

FIG. 13 shows a mode of the device 10 formed to be a cover for underlying printed media wherein frangible lines 31 are imparted to the sections of the cover 12, rendering them removable and the cover 12 of the device 12 adjustable in size to match a size of underlying printed media pages 21.

FIG. 14 shows a mode of the device 10 herein, wherein an object such as a product 44 acts as the trigger to activate the media player 16 to play sound and or video concerning the product when moved from being proximate to a sensor 46, or for instance when an onboard accelerometer in the product notes movement. This mode allows for products 44 to be placed on or adjacent the device 10 and to activate the media when the product if moved. The cover 12 can also have printed or other indicia in page form bound to the cover relating to the product or its use for example.

FIG. 15 depicts a typical mode of the method of forming a book or bound album, such as in FIGS. 1-3, with internal paged indicia and the cover 12 with media player 16. In the mode as shown, the buyer chooses 50 digital files of chosen indicia 50 such as photos to include in the page of the album. The buyer also chooses media 54 to include in the media player which may include a slide show of the indicia on the pages inside the cover 12, or video and/or audio related thereto, or both.

Once chosen the electronic files relating to the chosen indicia 50 and chosen media 54 are communicated to an album producer 56 who employs printing and binding to place pages with the chosen indicia 50 within a cover 12.

The producer 56 thereafter prints 58 or positions the chosen indicia 50 onto pages to be bound to the cover 12 to form an album. For examples photographs of wedding or collages thereof on multiple pages bound to the cover 12.

The producer 56 also communicates 60 the digital files of the chosen media 54 into electronic memory of a media player engaged with or engageable with the cover 12. Such can be communicated by wired or wireless communication depending on the components included with the media player.

The producer 56 also binds the pages 64 of indicia printed or otherwise formed, to the cover 12 housing the media player with the chosen media 54 in electronic memory.

The album being formed and finished is then tendered to the buyer 64 by a pickup at the producer's 56 business, or by shipping to the user.

Finally, the buyer or his designate, such as in a gift, is able to view the pages of chosen indicia 50 bound to the cover 12 as well as play the chosen media 54 on the media player engaged to the cover 12 which preferably relates to the chosen indicia 50 such as videos of a wedding for example, or a slide show of the wedding which includes the chosen indicia 50 printed to the pages inside the formed album.

This method will work especially well over the internet where buyers will be given an graphic interface (not shown but well known in the art) to allow them to select the digital files for chosen media 54, and digital files for chosen indicia 50, and communicate both to the producer 56 electronically using the directions and links on the graphic interface.

Thereafter the producer 56 would form the pages with chosen media, such as photographs, and place the digital files for chosen media 54 into the media player in the cover, and bind the cover to the pages. Such would work well in the existing electronic system where buyers send in photos to large chain stores such as TARGET or WALMART, and the album is formed at the local store, in the aforementioned manner.

Any of the modes of the device herein can be used in this method, or combinations of such. For instance using the cover 12 of FIG. 13 which is adapted, such as by printing, or recesses, or frangible lines, to be cut and sized along lines 31 to form the correct size for what is being printed, would work well to adapt to the varying sizes of printed indicia on pages in the album engaged to the cover 12, such as photos. As can be seen, by using the cover 12 as the housing for the media player, it can be permanently attached to the album which has the pages internally of chosen indicia relating to the chosen media, and cost is minimized since the media player uses the cover to house the electronics and memory such as in FIGS. 7 and 10-12.

As noted, any of the different configurations and components can be employed with any other configuration or component shown and described herein. Additionally, while the present invention has been described herein with reference to particular embodiments thereof and steps in the method of production, a latitude of modifications, various changes and substitutions are intended in the foregoing disclosures, it will be appreciated that in some instance some features, or configurations, or steps in formation of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. An album with bound pages, comprising:
a cover, said cover being bound to a plurality of pages bearing indicia thereon;
said cover including a media player engaged therewith, said media player having batteries, computer memory, and a computing component running software adapted to display digital media files stored in said computer memory, on a display of said media player; and
a control operatively engaged to said media player to activate a display of said digital files on said display, whereby media files relating to said indicia on said plurality of pages can be viewed by a user concurrent to a viewing of said pages.

2. The album of claim 1, wherein said cover is configured with lines upon the cover, said cover separable along said lines to resize said cover, whereby said cover is resizeable to match a size of said plurality of pages bound thereto in a said album.

3. A method of forming the device of claim 1 comprising:
providing said buyer a graphic interface displayable on a computer, over a network;
having the user employ said graphic interface to designate chosen digital files relating to indicia for printing to said pages;
having the user employ said graphic interface to designate chosen digital files relating to media for playing upon said media player;
having said user communicate to an album producer, over said network, both said chosen digital files relating to said indicia, and said digital files relating to media for playing upon said media player;
having said album producer impart said indicia to pages for including in said album using said chosen digital files relating to said indicia;
having said album producer communicate said chosen digital files relating to media to said electronic memory in operative engagement with said media player engaged with said cover; and
having said album producer engage said cover to said pages to form said album if not already so engaged.

4. The album with bound pages of claim 1 wherein said control includes buttons on or in said cover.

5. The album with bound pages of claim 1 wherein said control a proximity sensor in operative communication with a product placed on or adjacent to said cover; and
movement of said product causing said proximity sensor to activate said media player.
